(19) United States
(12) Patent Application Publication
(10) Pub. No.: US 2026/0160359 A1
(43) Pub. Date: Jun. 11, 2026

(54) SUBSEA TOOL AND METHOD FOR HANDLING HYDRAULIC HOSES

(71) Applicant: Petróleo Brasileiro S.A. – Petrobras, Rio de Janeiro (BR)

(72) Inventors: Pedro Paulo Bezerra DA CUNHA CASTRO, Macaé (BR); Andre Luiz Bevilaqua SANTANA, Macaé (BR)

(21) Appl. No.: 19/400,754

(22) Filed: Nov. 25, 2025

(30) Foreign Application Priority Data
Dec. 9, 2024 (BR) 1020240256670

(51) Int. Cl. F16L 1/20; B63G 8/00

(52) U.S. Cl. CPC F16L 1/207; B63G 8/001; B63G 2008/005

(57) ABSTRACT

The present disclosure is applied to the field of technologies for maintenance of subsea equipment used in the oil and gas industry and, more particularly, relates to a subsea tool for handling hydraulic hoses comprising: a body having a lateral hole with internal threads extending through one of the side walls of the body, a central gap; a handling shaft; and a tightening shaft; wherein the handling shaft is fixed to a lower portion of the body; and wherein the tightening shaft is positioned laterally with respect to the body, being supported by a support element of the body. The tightening shaft has a threaded element fixed to a distal end thereof, the threaded element passing through the lateral hole toward the gap and being configured to move by rotation of the tightening shaft. The present disclosure further relates to a method for handling hydraulic hoses using the subsea tool.

### CROSS-REFERENCE TO RELATED APPLICATIONS

This application claims priority to Brazilian Patent Application No. 1020240256670, filed Dec. 9, 2024, which is incorporated herein in its entirety by reference thereto.

### FIELD

The present disclosure is applied to the field of technologies for maintaining subsea equipment used in the oil and gas industry and, more particularly, relates to a subsea tool for handling hydraulic hoses by a remotely operated vehicle (ROV) and to a method for handling hydraulic hoses using said subsea tool.

### BACKGROUND

In the context of subsea operations in oil production systems, the most common way to control subsea equipment is through hydraulic actuation, carried out by means of hydraulic hoses. Occasionally, it may be necessary to perform interventions on the equipment involving the hoses to, for example, remedy a leak in the hoses themselves in order to restore control over a given equipment function, change which hose controls a specific function, among others. During such interventions, it is necessary to handle the hoses to enable disconnection, reconnection, replacement of the connector (re-termination), with the objective of performing the intended intervention.

Traditionally, the handling of hydraulic hoses is performed by divers, since there is no tool operated by a remotely operated vehicle (ROV) that allows hose handling without damaging them, since the ROV manipulator has a rough surface and lacks precise control of the gripping force applied. Thus, current techniques for handling subsea hydraulic hoses are limited to subsea equipment located at water depths of up to 300 meters.

Therefore, there is a need in the prior art for the development of a tool capable of handling hydraulic hoses of subsea equipment by means of a ROV, without causing damage to the hoses, in order to enable various maintenance activities on subsea equipment, such as the disconnection/reconnection of hydraulic terminals and the installation of quick-connect type connectors at the ends of hoses.

Accordingly, the present disclosure provides a tool (vise-type) to accommodate a portion of the hydraulic hose without causing abrasion damage, in addition to allowing control of the gripping force applied to the hose, which is not possible using only the ROV manipulator. The tool of the present disclosure has a body for supporting the hose, a shaft adapted for handling by the ROV, and a tightening shaft for securing the hose to the body.

### State of the Art

The state of the art shows some documents that disclose subjects within the technological field of the present disclosure.

Document U.S. Pat. No. 8,844,975B2 relates to a hose intervention clamp, which is provided to clamp a hose/nozzle assembly, wherein the hose/nozzle assembly has a hose and a nozzle containing a locking groove. The hose intervention clamp includes a locking ring, an upper clamp portion, and a lower clamp portion pivotally connected to the upper clamp portion. The upper and lower clamp portions are pivotable relative to each other from a first at least partially open position to a second locking position, and in the second locking position, the upper and lower clamp portions define a recess for receiving the hose/nozzle assembly. The locking ring is configured to be received in the locking groove when the upper and lower clamp portions are in the second locking position. A hose intervention clamp system includes a hose/nozzle assembly having a hose and a nozzle containing a locking groove, and the clamp described.

Furthermore, document U.S. Pat. No. 8,757,929B2 relates to a hose splicing system, which comprises a first securing tool and a hose-fitting adapter. The first securing tool includes a first securing member and a second securing member. An inner surface of at least one of the first securing member and the second securing member includes a recess configured to receive an end of a hose. In addition, the first securing tool includes a hinge coupled to the second securing member. Further, the first securing tool includes a locking member pivotally coupled to the first securing member. The hose-fitting adapter has a central axis, a first end configured to be inserted into the end of the hose, a second end configured to be releasably connected to a rigid hose-end connector, and a through-hole extending axially from the first end to the second end.

However, both of the aforementioned documents (U.S. Pat. Nos. 8,844,975B2 and 8,757,929B2) disclose subsea tools for handling hoses and connections of a specific diameter, since closing the tools disclosed in those documents (through clamp portions) would not be possible if the hose had a diameter larger than that defined by the dimensions of the upper and lower clamp body portions. Additionally, if the hose has a smaller diameter than the clamp body of U.S. Pat. Nos. 8,844,975B2 and 8,757,929B2, it is clear that it will not be properly secured; that is, the clamp body will close completely, but there will be a gap between the external surface of the hose and the inner surface of the clamp body (a loose fit).

On the other hand, the subsea tool of the present disclosure is capable of working with various hose diameters, because hose fixation is achieved by advancing a tightening shaft, which can be easily adjusted. That is, the tool of the present disclosure allows use with various hose gauges, unlike the solutions presented in the aforementioned documents. Furthermore, due to its adjustable tightening feature for different sizes, the tool of the present disclosure has potential for application in handling items other than a hose that are difficult to access or that may be at risk of damage if moved solely with the ROV manipulator. For example, a rectangular component of subsea equipment such as a panel, a shaft, among others.

It should also be noted that the tool of the present disclosure has a simpler securing mechanism, relying only on the rotation of the tightening shaft, whereas the tools in documents U.S. Pat. Nos. 8,844,975B2 and 8,757,929B2 require closing the clamp halves, positioning the closing screw, and then completing the fastening.

### BRIEF DESCRIPTION

The solution of the present disclosure to the technical problem previously identified consists in the development of a tool that enables the ROV to handle hydraulic hoses without damaging them, in order to carry out maintenance of subsea equipment both in shallow water depths and in locations where human diving is not possible, thus reducing personnel exposure to risk.

Some non-limiting examples of use of the tool of the present disclosure are: making and unmaking threaded unions between hoses; serving as support to allow installation of quick-connect type connectors at the end of the hose; and serving as support for direct connection between hoses.

Accordingly, the objects and advantages of the present disclosure are achieved by providing a subsea tool for handling hydraulic hoses comprising: a body having a lateral hole with internal threads extending through one of the side walls of the body; a central gap; a handling shaft; and a tightening shaft, wherein the handling shaft is fixed to a lower portion of the body; and wherein the tightening shaft is positioned laterally with respect to the body and supported by a support element of the body. The tightening shaft has a threaded element fixed to a distal end thereof, the threaded element passing through the lateral hole toward the gap and being configured to move by rotation of the tightening shaft.

In addition, the present disclosure also provides a method for handling hydraulic hoses using a subsea tool comprising: positioning the subsea tool beneath a hose portion; fitting a gap of a body of the subsea tool around the hose portion; and rotating a tightening shaft to advance a threaded element through a lateral hole toward the gap until contacting and securing the hose portion therein.

### BRIEF DESCRIPTION OF THE FIGURES

The preferred embodiments of this disclosure will be better understood when read in conjunction with the attached drawings. However, it must be understood that the disclosure under discussion is not limited only to the precise arrangements and instruments shown.

Thus, the present disclosure will now be described with reference to its typical embodiments and with reference to the appended drawings, in which:

FIG. 1 shows an isometric view of a subsea tool for handling hydraulic hoses, according to one embodiment of the present disclosure.

FIG. 2 shows a front view of a subsea tool for handling hydraulic hoses, according to one embodiment of the present disclosure.

FIG. 3 shows a top view of a subsea tool for handling hydraulic hoses, according to one embodiment of the present disclosure.

FIG. 4A shows an example of application of the subsea tool, in which it is used to undo a threaded union between two hydraulic hoses, according to one embodiment of the present disclosure.

FIG. 4B shows an example of application of the subsea tool, in which it is used as support for installing a quick-connect connector at the end of a hydraulic hose, according to one embodiment of the present disclosure.

FIG. 4C shows an example of application of the subsea tool, in which it is used as support for connecting two hydraulic hoses, according to one embodiment of the present disclosure.

FIG. 5A shows field use of the subsea tool by a ROV to handle a hydraulic hose, according to one embodiment of the present disclosure.

FIG. 5B shows field use of the subsea tool by a ROV as support for connecting two hydraulic hoses, according to one embodiment of the present disclosure.

### DETAILED DESCRIPTION

Reference is made in detail below to the preferred embodiments of the present disclosure illustrated in the attached drawings. Whenever possible, the same or similar reference numbers will be used throughout the drawings to refer to the same or similar characteristics. It should be noted that the drawings are in simplified form and are not shown to precise scale, so minor variations are anticipated.

The present disclosure relates to a subsea tool for handling hydraulic hoses, applied in maintenance operations of subsea equipment. The tool provides a smooth interface to accommodate a hose, or any other item, regardless of its cross section, preventing abrasion damage, and allowing control of the gripping force applied to the hose, which is not possible using only a ROV manipulator. To further facilitate handling by the ROV, the tool provides an adapted shaft.

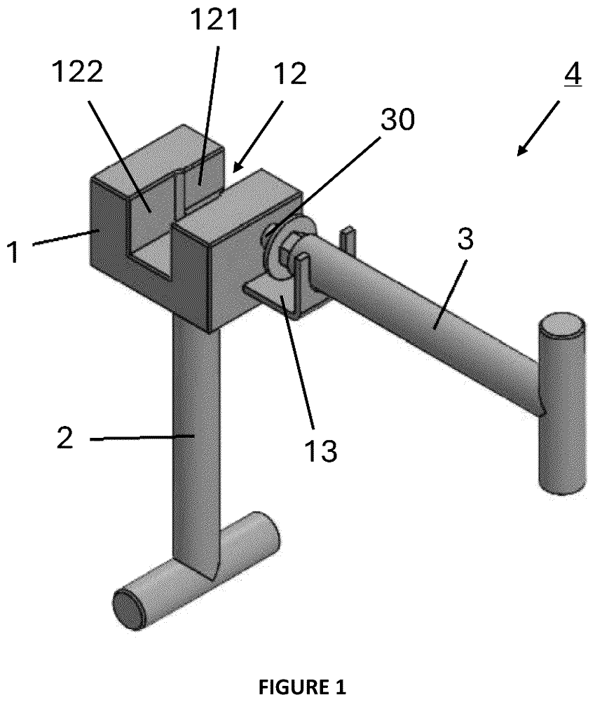

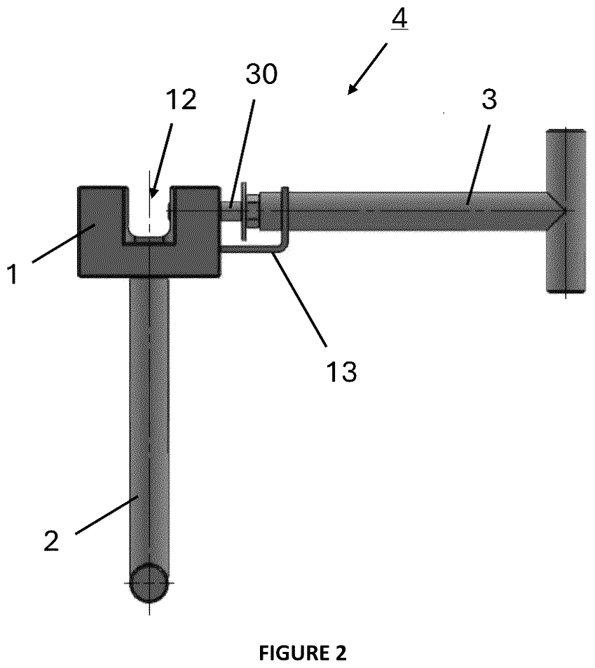

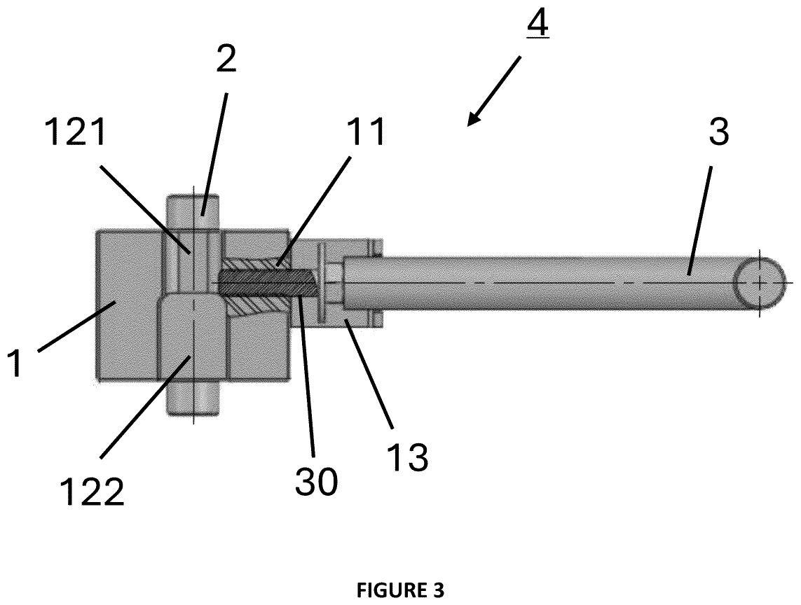

Thus, reference is made to FIGS. 1, 2, and 3, which show a subsea tool (4) for handling hydraulic hoses, according to one embodiment of the present disclosure. The subsea tool (4) comprises: a body (1); a handling shaft (2); and a tightening shaft (3). The body (1) has a U-shaped block configuration with a central gap (12) that extends longitudinally along the body (1). In some embodiments of the present disclosure, the gap (12) includes a first fitting portion (121) and a second fitting portion (122), wherein the spacing between the inner walls of the first fitting portion (121) is smaller than the spacing between the inner walls of the second fitting portion (122). The transition from one spacing to the other is made smoothly by means of chamfers, as can be seen in FIGS. 1-3. This difference in spacing between the walls of the first fitting portion (121) and the second fitting portion (122) allows not only a hydraulic hose to be fitted, but also a connector, such as a connector located at the end of a hydraulic hose. Thus, the tool (4) is capable of accommodating not only equipment with a regular profile (such as a hose with a tubular shape along its entire length), but also other parts of equipment with irregular profiles, such as connectors and other elements. Nevertheless, it should also be noted that, in other embodiments of the present disclosure, the gap (12) of the tool may have the same wall spacing along its entire length. In this case, the gap (12) has only a single fitting portion, without a transition between two fitting portions with different spacings.

Furthermore, the body (1) further comprises a lateral hole (11) with internal threads extending through one of the side walls of the body (1).

Additionally, according to one embodiment of the present disclosure, the body (1) comprises a support element (13) fixed to the external surface of the side wall of the body (1) to support the tightening shaft (3).

In one embodiment of the present disclosure, the handling shaft (2) is fixed to a lower portion of the body (1), the fixation being performed by welding or another suitable securing means. The handling shaft (2) allows a ROV, or even a human diver, to hold and maneuver the tool (4), both during transport and to position the tool (4) under the hose or connector.

The tightening shaft (3) has a threaded element (30) fixed to a distal end thereof, the threaded element (30) passing through the lateral hole (11) toward the gap (12) and being configured to move (i.e., advance and retract) by rotation of the tightening shaft (3). The threaded element (30) may be, for example, a screw.

Thus, by rotating the tightening shaft (3) in a first direction (clockwise or counterclockwise, depending on the contact interface and the direction of the threads of the threaded element and the lateral hole), the threaded element (30) advances toward the gap (12) until it contacts and secures the hose or connector. Similarly, by rotating the tightening shaft (3) in a second direction opposite the first direction defined for advancement (counterclockwise or clockwise), the threaded element (30) retracts away from the gap (12), entering the lateral hole (11) and leaving the gap (12) free. It should be noted that the final retraction stroke (i.e., the end limit of retraction) is determined by the support element (13), which acts as a stop for the threaded element (30) and prevents the tightening shaft (3) from detaching from the tool (4) during operation.

Accordingly, in a preferred embodiment of the present disclosure, the subsea tool (4) for handling hydraulic hoses comprises: a body (1) having a lateral hole (11) with internal threads extending through one of the side walls of the body (1); a central gap (12); a handling shaft (2); and a tightening shaft (3), wherein the handling shaft (2) is fixed to a lower portion of the body (1); and wherein the tightening shaft (3) is positioned laterally with respect to the body (1), being supported by a support element (13) of the body (1). The tightening shaft (3) has a threaded element (30) fixed to a distal end thereof, the threaded element (30) passing through the lateral hole (11) toward the gap (12) and being configured to move by rotation of the tightening shaft (3).

Next, a method for handling hydraulic hoses using the subsea tool (4) will be described, in which the synergistic operation of the components of the present disclosure will become even more evident to a person skilled in the art.

Thus, the method comprises a first step of positioning the tool (4), by means of the handling shaft (2), under a hose portion and then fitting the gap (12) of the body (1) around the hose portion. Then, a rotation is performed, by means of the tightening shaft (3), to advance the threaded element (30) through the lateral hole (11) toward the gap (12) until it contacts and secures the hose portion therein. It is noted that the compression force on the hose portion is controlled as a function of the number of turns applied to the tightening shaft (3). Once the hose is secured, it can be safely moved by the ROV, or by a human diver, through the handling shaft (2). To release the hose portion, the tightening shaft (3) is rotated in the opposite direction from the direction in which the threaded element (30) advances.

Thus, according to a preferred embodiment of the present disclosure, the method for handling hydraulic hoses using a subsea tool (4) comprises: positioning the subsea tool (4) under a portion of hose; fitting a gap (12) of a body (1) of the subsea tool (4) around the hose portion; and rotating a tightening shaft (3) to advance a threaded element (30) through a lateral hole (11) toward the gap (12) until contacting and securing the hose portion therein.

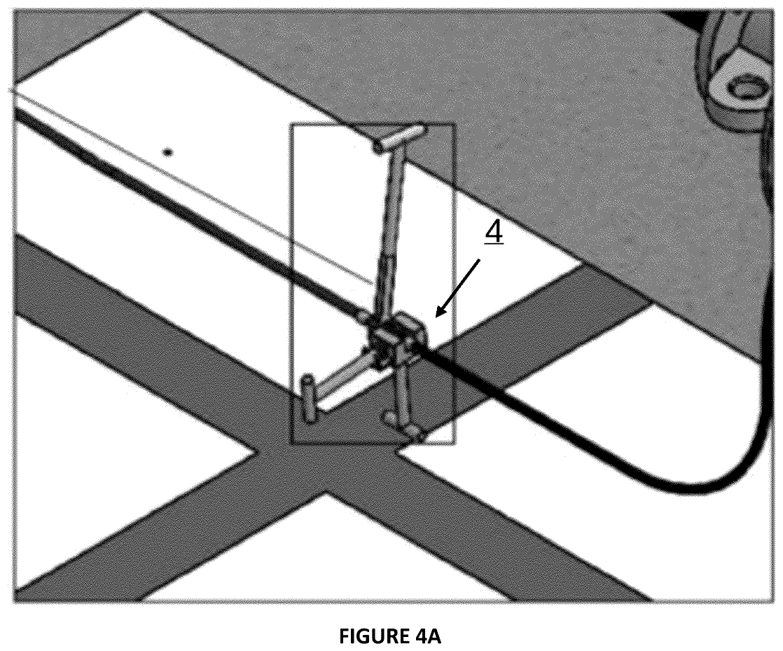

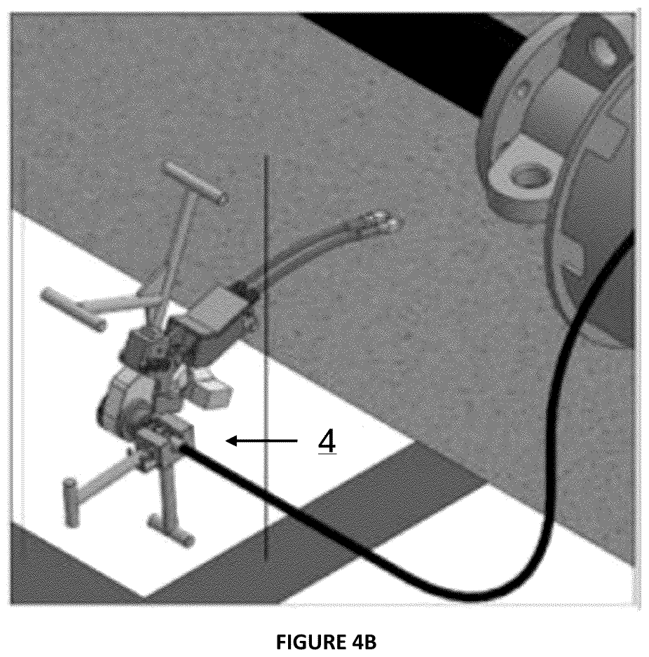

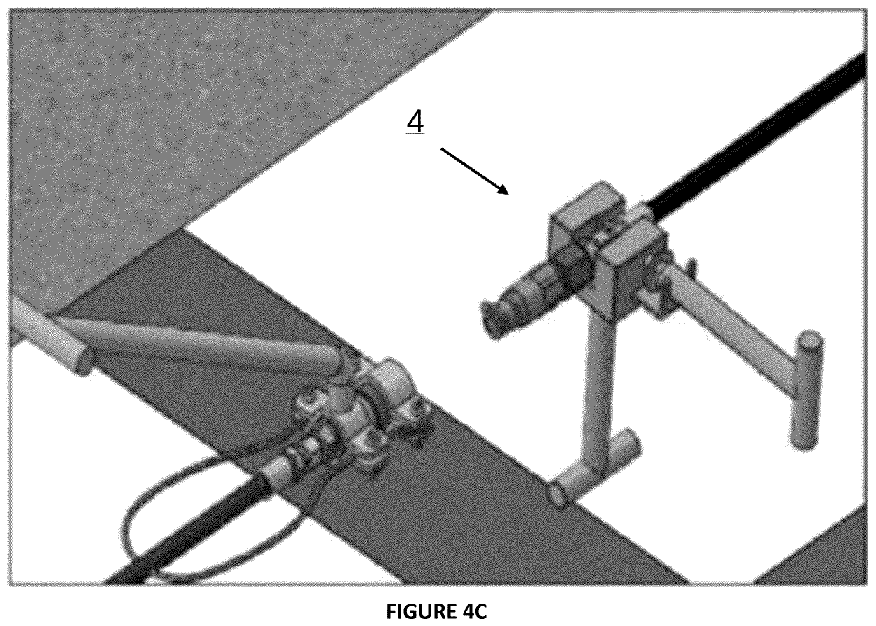

Some examples of use of the subsea tool (4) and its associated method include:—making and unmaking threaded unions between hoses, as shown in FIG. 4A, in which the tool (4) is fitted at a connection region between two hydraulic hose ends, each with its corresponding connector; serving as support to allow installation of quick-connect type connectors at the end of the hose, as shown in FIG. 4B; and serving as support for direct connection between hoses, as shown in FIG. 4C.

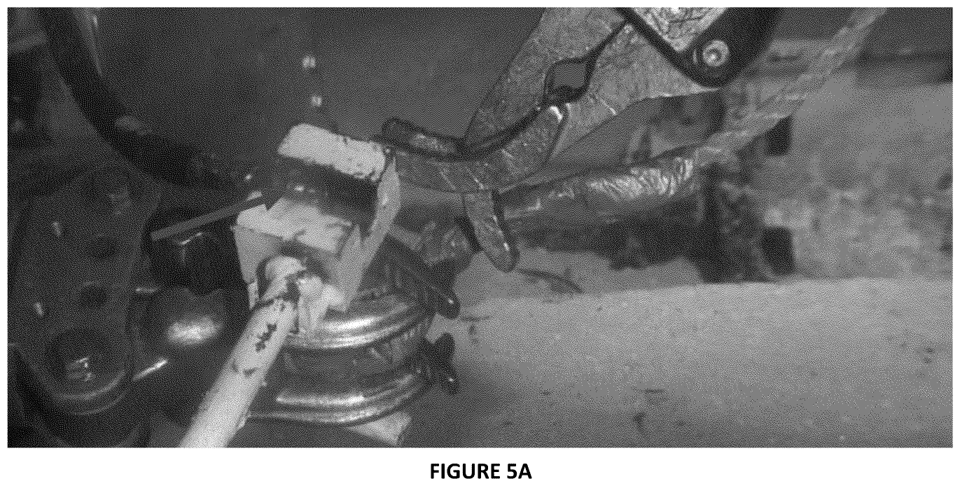

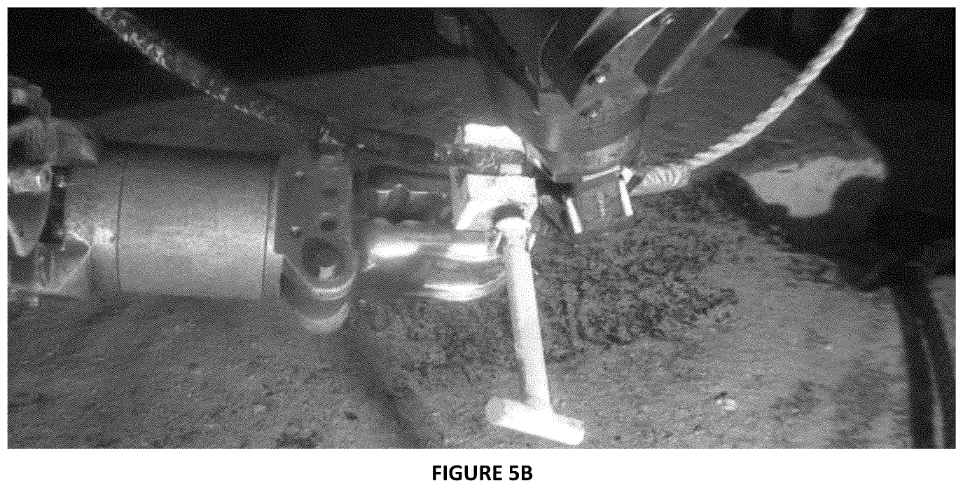

Furthermore, FIGS. 5A and 5B illustrate examples of application of the subsea tool (4) handling portions of hydraulic hoses in the field, in which FIG. 5A shows a ROV gripper holding the handling shaft (2), while a portion of hydraulic hose, indicated by an arrow, is secured in the body (1) of the tool (4) after rotation of the tightening shaft (3) to advance the threaded element (30). In turn, FIG. 5B shows the subsea tool (4) being used as support to connect two hydraulic hoses, in which the tool (4) secures a portion of a first hydraulic hose while another ROV gripper performs the engagement using a second hydraulic hose.

Therefore, it is verified that the technical solution proposed through the development of the subsea tool (4) of the present disclosure enables hydraulic hoses of subsea equipment to be handled without damaging them, in deep-water scenarios where this was previously not possible, and also eliminates the need for human divers in shallow-water cases. Therefore, in addition to improving personnel safety, the present disclosure makes it possible to restore the safe operation of subsea equipment.

In the application of the subsea tool of the present disclosure, the following benefits and advantages may be considered, among others:—enabling maintenance of hydraulic hoses of subsea equipment in deep water, thereby restoring safe operation; reducing human exposure to risk in shallow-water scenarios by replacing the need for divers with the use of an ROV; providing a simple, low-cost solution with reduced manufacturing time.

Those skilled in the art will value the knowledge presented herein and may reproduce the disclosure in the disclosed embodiments and other variants, as covered by the scope of the appended claims.

1. Subsea tool (4) for handling hydraulic hoses, characterized in that it comprises:
a body (1) containing a lateral hole (11) with internal threads extending through one of the side walls of the body (1);
a central gap (12);
a handling shaft (2); and
a tightening shaft (3);
wherein the handling shaft (2) is fixed to a lower portion of the body (1);
wherein the tightening shaft (3) is positioned laterally with respect to the body (1), being supported by a support element (13) of the body (1);
the tightening shaft (3) has a threaded element (30) fixed to a distal end thereof, the threaded element (30) passing through the lateral hole (11) toward the gap (12) and being configured to move by rotation of the tightening shaft (3).

2. Subsea tool (4) according to claim 1, characterized in that the body (1) has a U-shaped block configuration.

3. Subsea tool (4) according to claim 1 or 2, characterized in that the gap (12) includes a first fitting portion (121) and a second fitting portion (122), wherein the spacing between the inner walls of the first fitting portion (121) is smaller than the spacing between the inner walls of the second fitting portion (122).

4. Subsea tool (4) according to claim 3, characterized in that the transition in spacing between the walls of the first fitting portion (121) and the second fitting portion (122) is made by means of chamfers.

5. Subsea tool (4) according to claim 1 or 2, characterized in that the gap (12) has the same wall spacing along its entire length.

6. Subsea tool (4) according to any of the preceding claims, characterized in that the support element (13) is fixed to the external surface of the side wall of the body (1) to support the tightening shaft (3).

7. Method for handling hydraulic hoses using a subsea tool (4) as defined in any of claims 1 to 6, characterized in that it comprises:
positioning the subsea tool (4) under a portion of hose;
fitting a gap (12) of a body (1) of the subsea tool (4) around the hose portion; and
rotating a tightening shaft (3) to advance a threaded element (30) through a lateral hole (11) toward the gap (12) until contacting and securing the hose portion therein.
